(19) United States
(12) Patent Application Publication
(10) Pub. No.: US 2008/0143026 A1
(43) Pub. Date: Jun. 19, 2008

(54) Material for Coating Iron Ore Pelletizing Disks and Drums and a Constructive Arrangement for Pelletizing Disks and Drums

(75) Inventors: Alessandro Bravim, Vitoria Espirito Santo (BR); Armando Mauricio Max, Vitoria Espirito Santo (BR); Fabiano Florencio Costa, Vitoria Espirito Santo (BR); Jose Antonino Alves E Silva Reis, Vitoria Espirito Santo (BR); Leonidio Stegmiller, Vitoria Espirito Santo (BR); Maykon Lyra Herzog, Vitoria Espirito Santo (BR); Reinaldo Walmir De Jesu, Vitoria Espirito Santo (BR)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: COMPANHIA VALE DO RIO DOCE, Minas Gerais (BR)

(21) Appl. No.: 11/908,743

(22) PCT Filed: Mar. 16, 2006
(86) PCT No.: PCT/BR2006/000051

§ 371 Date: Sep. 14, 2007

(30) Foreign Application Priority Data
Mar. 17, 2005 (BR) MG000599

(51) Int. Cl. C21D 8/00; C09C 1/22

(52) U.S. Cl. 266/249; 106/460

(57) ABSTRACT

The invention is directed to a material for coating iron ore pelletizing disks and drums and a constructive arrangement for pelletizing disks and drums that is comprised of a mixture of binders with ores (that may or not be ground) of the group consisting of iron, manganese or others, the inclusion of fluxes being also provided. The bottom (1) of the disk or drum (5) is coated with a cold cure coating material, vegetal oils, minerals and/or gel-forming products in order to form a bottom layer (2) that may or not be on the surface, and polyethylene plates (7) to aid in the separation of the fines from the pellets (6) can also be incorporated into the inner perimetral edge (6) of said pelletizing disk or drum (5).

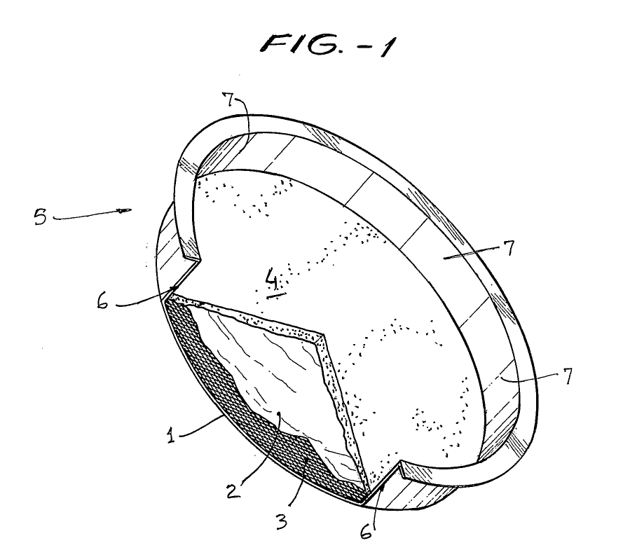

The present invention is directed to a mixture of binders and a number of ores that have the same or distinct natures of the material being pelletized, said mixture being meant for the inner coating of iron ore pelletizing disks and drums, more specifically to a mixture that is comprised of binding material the purpose of which is the formation of the bottom and side layers of both pelletizing disks and pelletizing drums, as well as a constructive arrangement for pelletizing disks.

In the mining field, the fine iron ores from the mines are either ground together with fluxes (limestone, dunnite, magnesite, and the like) or dispensed separately, thus receiving a binder load (hydrated lime, bentonite, organic binder, and the like) later on for the purpose of agglutinating the micro-particles.

In the manufacture of pellets, this pre-homogenized mixture is subjected to the pelletizing process by using the related equipment that are usually called pelletizing disks or plates and drums, wherein said fine micro-particles (40 to 95% passing through 0.045 mm) are agglomerated, thus forming a generally spherical pellet having an average diameter according to the customers' requirements.

Such damp pellets, now showing a humidity content of 8.0 to 11%, are then passed through sieves for the removal of both undersized and oversized material, said undersized material and oversized material being returned to the pelletizing disks or drums after being comminuted, and the pellets that have been sorted according to the desired diameter (i.e., an average diameter between 12 and 13 mm) are placed into the sintering furnace so that they can be hardened.

After the sintering process, such pellets also are passed through suitable sieves for the removal of fines, which are usually sold as “Sinter Feed” type ore, and the pellets calcined without the fines are shipped to the domestic or foreign market or used in the production of pig iron or iron sponge and then steel.

In the above described process, the pelletizing disk is defined as being a rotating metallic plate that can exhibit the most diverse diameters, inclinations and speeds, which plate is provided with scrapers inside same that act as stabilizers of the planeness and height of the disk bottom layer, as well as directors of the flow of material to be pelletized, and by using the process that rolls and agglutinates the particles, in association with the centrifugal force of the plate, the desired diameter of the pellet is then attained.

In said equipment (pelletizing disk), a screen and a set of angle bars are welded on the bottom thereof for the purpose of fixing the material to be deposited, thus defining the bottom layer.

The purpose of the material to be applied on the disk bottom grid in the shape of a layer is to provide a plain uniform rolling track without any shoulder, for the formation of pellets that exhibit the highest sphericity that can be attained, in accordance with the grain sized specification required by the customer and also to protect the disk against a possible contact between the metallic bottom portion and the scrapers.

However, as is known by those skilled in the art, in many instances the mixture to be pelletized does not have any suitable property required for the pelletizing process such as, for example, the high resistance to plastic and elastic deformation.

This inconvenience is mainly due to the high humidity and fragility of the material that is generally used for making the disk bottom layer, which, in view of the fact that it is basically comprised of the mixture being pelletized (ground ore, fluxes and binders), often results in the release of same from said bottom layer, thus creating fissures and cracks.

Therefore, as such problems on the disk side and bottom layers are identified for each stop for its maintenance shutdown, a loss in the production of pellets equivalent to the disk production takes place.

Another inconvenience in the state of the art is related to the difficulty in satisfying the grain size customer requirements for the produced pellets.

Another inconvenience in the state of the art is related to the increased generation of fines mixed to the raw pellets at the outlet of the pelletizing disks. This increased generation of fines consequently brings about an increase in the return rate that also represents a production loss.

In order to eliminate such inconveniences, the research centers have been increasingly trying to develop new materials that can replace the ones that result in production losses to the company.

Therefore, one of the objects of the present invention is to provide a material for coating iron ore pelletizing disks and drums and a constructive arrangement for pelletizing disks that can assure a uniformity in the formation of the pellets in the pelletizing process.

Another object of the present invention is to provide a material for coating iron ore pelletizing disks and drums and a constructive arrangement for pelletizing disks that can satisfy the requirements related to the physical qualities of the produced pellets when applied to pelletizing disks and drums, in order to reduce the complaints made by the customers.

Still another object of the present invention is to provide a material for coating iron ore pelletizing disks and drums and a constructive arrangement for pelletizing disks that make it possible to diminish the maintenance shutdown, thus preventing production losses.

A further object of the present invention is to provide a material for coating iron ore pelletizing disks and drums and a constructive arrangement for pelletizing disks that, when applied to pelletizing disks and drums, make it possible to reduce the consumption of heat energy in the calcining kilns.

Still another object of the present invention is to provide a material for coating iron ore pelletizing disks and drums and a constructive arrangement for pelletizing disks that, by satisfying the specifications of the pellets, can improve the quality of the end product.

These and other objects and advantages of the present invention are attained through the use of a material for coating iron ore pelletizing disks and drums that have the same or distinct natures of the material being pelletized, basically comprised of a mixture of binders with ores (that may or not be ground), of the group that consists of iron, manganese or the like, optionally also including fluxes.

The present invention is also directed to a constructive arrangement for pelletizing disks and drums coated with said material, thus providing said disks and drums with a bottom (or side) layer comprised of the binders mixed with iron ore, manganese or any other ore used in the pelletizing process, and said mixture can also contain fluxes and binders; also, polyethylene plates can be incorporated into the inner edge of said pelletizing disk or drum in order to aid in the removal of fines from the pellets.

Now the present invention will be described with reference to the accompanying drawing, wherein the sole FIGURE represents a partially cut perspective view of the pelletizing disk.

Amongst the possible alternatives for applying this material, two can be described herein: in the first one, the material is conformed and arranged on the surface of the conventional and usual side and bottom layers of the pelletizing disk or drum (4), so that a portion of the final mixture that is comprised of binders and ores of the group consisting of iron, manganese or others, optionally also including fluxes, is sprayed on said surface in such a way that the final material comprises a fine surface layer containing the bottom and side conventional ore together with the mixture that has been sprayed thereon.

In the second alternative and in accordance with the illustration, the material for coating iron ore pelletizing disks and drums is comprised of the mixture of a binder with iron ore, manganese or any other ore used in the pelletizing process, and said mixture can optionally contain fluxes.

Thus, the present invention also is directed to a constructive arrangement for pelletizing disks and drums that are provided in the bottom 1 with a layer of a mixture of a binder with iron ore, manganese or any other ore used in the pelletizing process 2 disposed between a metallic frame or screen 3 and the layer comprising the ore to be pelletized 4. The metallic frame 3 extends throughout the whole circular area of the bottom of disk 5, having angle bars (not illustrated) attached to the screens, also for the purpose of keeping the integrity of the bottom of the disk, thus preventing same from releasing therefrom when the disk is operated.

Further, polyethylene plates 7 that aid in the separation of the fines from the pellets can also be incorporated into the inner side wall 6 of the pelletizing disk 5, thus optimizing the pelletizing process.

Although a standard concept has been described and illustrated, it should be recalled that alterations to the design are possible and attainable without departing from the scope of the present invention.

1. A material for coating iron ore pelletizing disks and drums, characterized by comprising a mixture of binders with ores (that may or not be ground) of the group consisting of iron, manganese or others, that have the same or distinct natures of the material being pelletized.

2. The material for coating iron ore pelletizing disks and drums according to claim 1, characterized in that the inclusion of fluxes is also provided.

3. A constructive arrangement for pelletizing disks and drums, characterized in that the bottom thereof is coated with the material as defined in claim 1, thus forming a bottom coating layer of a mixture of cold cure materials, vegetal oils, minerals and/or gel-forming products, wherein polyethylene plates can also be incorporated into the inner perimetral edge of said pelletizing disk or drum.

4. The constructive arrangement for pelletizing disks and drums according to claim 3, characterized in that the bottom layer of the new material is disposed on the conventional bottom surface itself and/or between a metallic frame or screen and the layer formed by the ore itself, wherein said metallic frame extends throughout the whole area of the circular portion of the disk and is supported by angle bars, as well as other configurations of possible applications.

5. A constructive arrangement for pelletizing disks and drums, characterized in that the bottom thereof is coated with the material as defined in claim 2, thus forming a bottom coating layer of a mixture of cold cure materials, vegetal oils, minerals and/or gel-forming products, wherein polyethylene plates can also be incorporated into the inner perimetral edge of said pelletizing disk or drum.
